(19) United States
(12) Patent Application Publication
(10) Pub. No.: US 2009/0084147 A1
(43) Pub. Date: Apr. 2, 2009

(54) ELECTRIC LOCK DEVICE

(75) Inventors: Yukitaka Mizutani, Nagoya-Shi (JP); Kazuya Yoshida, Nagoya-Shi (JP); Toru Ando, Nagoya-Shi (JP)

Correspondence Address: BURR & BROWN, PO BOX 7068, SYRACUSE, NY, 13261-7068, US

(73) Assignee: Aiphone Co., Ltd., Nagoya-Shi (JP)

(21) Appl. No.: 12/211,262

(22) Filed: Sep. 16, 2008

(30) Foreign Application Priority Data
Sep. 28, 2007 (JP) 2007-253633

(51) Int. Cl. E05B 47/00

(52) U.S. Cl. 70/277

(57) ABSTRACT

An electric lock device which can be used suitably regardless of an operation mode of a thumb-turn. In the electric lock device, components to be placed at a peripheral part of the thumb-turn are miniaturized by separating a control device and an electric power supply, which require a comparatively large space, from a thumb-turn cover. The electric lock device includes a cover device internally having a motor and a thumb-turn cover, a control device internally having a control part, and a power supply part built-in the control device for supplying power to the control device and the motor. Therefore, the cover device can be more compactified than that of a conventional electric lock device in which the control part and the power supply part are integrally placed with the thumb-turn cover and the motor. The cover device can be attached proximity to a thumb-turn without being protruded from a door.

### FIELD OF THE INVENTION

The present invention relates to an electric lock device having a first casing internally having a driving device and a second casing internally having a control device for controlling the driving device as separate bodies.

### BACKGROUND ART

Conventionally, there are various electric lock devices post-attached to a thumb-turn lock on a door or the like for being carried out by an electric locking operation instead of a manual operation. For example, an electric lock device disclosed in the patent document 1 is known.

The electric lock device disclosed in the patent document 1 includes a thumb-turn cover having a recessed part capable of housing a thumb-turn, and connects the thumb-turn cover to a motor through a gear mechanism. In the electric lock device, locking and unlocking operations are carried out by rotating and driving a motor so as to turn the thumb-turn cover and then the thumb-turn. Here, the rotating and driving of the motor is electrically controlled by a control device.

[Patent Document 1] Japanese Unexamined Patent Publication No. 2005-23688

### DISCLOSURE OF THE INVENTION

### PROBLEM TO BE SOLVED BY THE INVENTION

In the electric lock device disclosed in the patent document 1, the thumb-turn cover, the driving device, and the control device are provided wholly in one control box. Therefore, a control box is increased in size and thus cannot be placed at any place, depending on a placing position of the thumb-turn, the shape of the door, or the like, because the box could be protruded from the door.

Further, although the ready-made thumb-turn generally takes a vertical position while being unlocked and a horizontal position while being locked, there are not a few thumb-turns taking a vertical position while being locked. Further, there is a thumb-turn which is carried out a locking/unlocking operation by turning from an inclination position at 45° to an inclination position at the contrary 45°. In a conventional electric lock device in which the thumb-turn cover and the thumb-turn are directly connected or connected only in a predetermined position, an electric lock device main body needs to be placed with inclining from an original placing position. Therefore, there are problems that the electric lock device cannot be placed in a space of a peripheral part of the thumb-turn, and thus the appearance is deteriorated.

The present invention is made in light of the foregoing problems and is to provide an electric lock device which can be used properly regardless of an operation mode of a thumb-turn by miniaturizing components in a peripheral area of the thumb-turn and separating a control device and an electric power supply, which require a comparatively large space, from a thumb-turn cover.

### MEANS TO SOLVE THE PROBLEMS

To realize the above-described objective, the invention according to claim 1 is an electric lock device including a driving device for turning a thumb-turn, a thumb-turn cover attached for covering the thumb-turn and being turned corresponding to an operation of the driving device so as to turn the thumb-turn, and a control device for determining whether being locked or unlocked by a turning position of the thumb-turn cover and controlling the driving device. The electric lock device further includes a first casing internally having the driving device and the thumb-turn cover, and a second casing internally having the control device and an electric power supply built in the second casing for supplying electric power to the control device and the driving device.

According to this configuration, the first casing can be more compactified than that of a conventional electric lock device in which the control device and the electric power supply are placed integrally together with the thumb-turn cover and the driving device. Thus, the first casing can be attached proximity to the thumb-turn without being protruded from a door.

The invention according to claim 2 is an electric locking device in accordance with claim 1, where the thumb-turn cover includes a cylindrical member of which center axis is a turning axis extending backward in horizontal direction, and a plurality of engaging members is provided on an inner circumference of the cylindrical member. A transmission member having a holding member capable of holding the thumb-turn and an engaging part on an outer peripheral face to engage to the engaging member is housed in the cylindrical member. The thumb-turn cover and the thumb-turn are interlockably connected through the transmission member. An attaching angle with the cylindrical part of the transmission member is made changeable by turning and selecting the engaging member which the engaging part engages.

According to this configuration, when the thumb-turn cover and the thumb-turn are interlockably connected through the transmission member, the engaging member which the engaging part engages is turned and selected. This enables the attaching angle with the cylindrical part of the transmission member to be changeable. Therefore, the electric lock device can be placed regardless of an operation mode of an existing thumb-turn, and thus is excellent in versatility. Further, the first casing can be constantly placed with a fixed position, and thus the appearance is not deteriorated due to the placed first casing.

The invention according to claim 3 is an electric locking device in accordance with claim 1 or 2, wherein the thumb-turn cover is provided capable of advancing and retracting along a rotary axis. One of a projected part and a recessed part which are fitted each other is provided at the thumb-turn-cover, and the other part is provided at a gear mechanism for connecting the thumb-turn cover and the driving device. When the fitting of the projected part and the recessed part is released by a pushing-in operation of the thumb-turn cover towards a thumb-turn side, the connection by the gear mechanism is released, and then a turning operation of the thumb-turn cover can be carried out without the driving device being operated.

According to this configuration, an interlock between the driving device and the thumb-turn cover can be connected/released by the pushing-in operation of the thumb-turn cover towards the thumb-turn side. Thus, the locking and unlocking operations can be manually carried out with ease if necessary, and the excellent usability of the device is obtained. Further, since the unlocking operation can be manually carried out with ease, it is not necessary to provide a separate device for carrying out an unlocking operation of the electric lock device inside a house. Thus, a compactification of the device and simplification of a placing operation or the like can be achieved, and thus a reduction in cost can be promoted. Further, since a pushing-in operation of the thumb-turn cover is needed when the locking and unlocking operations are manually carried out, an illicit unlocking by a thumb-turn turning or the like can be effectively prevented.

### EFFECT OF THE INVENTION

According to the present invention, the first casing can be more compactified than that of a conventional electric lock device in which a control device and an electric power supply are placed integrally with a thumb-turn cover and a driving device. Further, the first casing can be attached proximity to a thumb-turn without being protruded from a door. Furthermore, since the electric power supply is housed in the second casing, a wiring work can be more simplified than that of a conventional electric lock device depended on an external power supply.

### PREFERRED EMBODIMENTS FOR CARRYING OUT THE INVENTION

One preferred embodiment of an electric lock device of the present invention will be described below referring to drawings.

FIG. 1 is an overall view to illustrate an electric lock device installed at a door, and FIG. 2 is a block configuration diagram of the electric lock device.

The electric lock device includes a cover device 2 for making a thumb-turn 1 (illustrated in FIG. 5) carry out locking and unlocking operations, a control device 3 for controlling an operation of the cover device 2, a sensor 4 for detecting an opening/closing state of the door, and an not-illustrated unlocking device (e.g., a card reader or 10 key), which is placed at an outside of the door for making the electric lock device carry out the unlocking operation from the outside.

First, the cover device 2 will be described referring to FIGS. 3 to 9.

FIG. 3 is an explanatory elevation view to illustrate the cover device 2, and FIG. 4 is an explanatory back elevation view to illustrate the cover device 2. Further, FIG. 5 is a front perspective explanatory view to illustrate the cover device 2 in a disassembled state, and FIG. 6 is a back perspective explanatory view to illustrate the cover device 2 in a disassembled state. Furthermore, FIG. 7 is a cross sectional explanatory view taken along an A-A line in FIG. 3. FIG. 8 is a cross sectional explanatory view taken along a B-B line in FIG. 3, and FIG. 9 is a cross sectional explanatory view taken along a C-C line in FIG. 3.

The cover device 2 includes a thumb-turn cover 7 attached for covering the thumb-turn 1, a motor 8 for turning the thumb-turn cover 7, and detection switches 9 and 9 for detecting a turning position of the thumb-turn cover 7. These are provided in a case member (a box body) which is formed by attaching a front cover member 6 to a base 5 as covering a front side of the base 5.

The base 5 is a trapezoid member having an opening window 10 on a bottom thereof for housing the thumb-turn 1 in the case member, and is attached in a fixed condition on the door through a metal fixture 11 fixed on a back face of the base 5. It should be noted that the metal fixture 11 is a metallic thin plate member having a circular hole 12, in which the thumb-turn 1 can be inserted, and a pair of fixing pieces 13 and 13, by which the base 5 can be fixed, on right and left edges thereof. The metal fixture 11 is adhered and fixed on the door with a not-illustrated seal member (e.g., a double-sided tape).

The thumb-turn cover 7 and a transmission member 14 are placed at a position ahead of the window 10 of the base 5 for covering the thumb-turn 1. The thumb-turn cover 7 is a cylindrical member having a finger knob part 7a at a front thereof and a center axis in a horizontal direction. The thumb-turn cover 7 is attached capable of turning around the center axis as a turning axis and capable of advancing and retracting along the axis in the horizontal direction. A circumference face 7b having a turning axis as a center axis is formed at the thumb-turn cover 7, and three operation protruding strips 7c, 7c, . . . for operating the detection switches 7 and 7 are installed in a protruding manner with a phase angle of 90° on the circumference face 7b. Further, later-described four recessed parts 7d, 7d, . . . for connecting the thumb-turn cover 7 and a gear mechanism 15 are provided with a phase angle of 90° at a front part of the circumference face 7b (that is, around the finger knob part 7a). Further, a cylindrical member 7e protruding backward is provided at a back of the thumb-turn cover 7, and eight recessed grooves 7f, 7f, . . . are installed with a recessing manner with a phase angle of 45° on an inner circumference face of the cylindrical member 7e. Reference 16 denotes a ring spring for biasing the thumb-turn cover 7 frontward. It is configured that the thumb-turn cover 7 is normally pushed out frontward by the ring spring 16 to be connected with the gear mechanism 15 described below, and, only when the thumb-turn cover 7 is pushed in backward against a biasing force of the ring spring 16, a connection of the thumb-turn cover 7 and the gear mechanism 15 is released. Further, a length in the anteroposterior direction of each operation protruding strips 7c is formed to have a length equal to or more than an advancing and retracting distance in the anteroposterior direction of the thumb-turn cover 7, that is, the length equal to or more than a distance in the anteroposterior direction from the pushing-out position to the pushing-in position. Furthermore, as for a relation between the finger knob part 7a and the operation protruding strips 7c, 7c, . . . , as illustrated in FIG. 10, when the finger knob part 7a takes a vertical position, that is a position indicating an unlocking state, a line connecting the opposed operation protruding strips 7c and 7c is to be horizontal, and the rest of the operation protruding strips 7c are made to be placed at a middle of an upper outer peripheral face.

Further, a transmission member 14 for transmitting turning of the thumb-turn cover 7 to the thumb-turn 1 is fitted in the cylindrical member 7e. The transmission member 14 is formed in a ring shape, and has eight engaging projections 14a, 14a, capable of engaging with a recessed groove 7f installed in a protruding manner on an outer peripheral face thereof. Further, a pair of holding rib pieces 14b and 14b is disposed at a center of the transmission member 14, and the thumb-turn 1 can be held between the holding rib pieces 14b and 14b. Therefore, when the transmission member 14 is fitted into the cylindrical part 7d while the thumb-turn 1 is held between the holding rib pieces 14b and 14b, the turning of the thumb-turn cover 7 can be transmitted to the thumb-turn 1. Thus, the thumb-turn 1 is turned along with the thumb-turn cover 7 being turned. It should be noted that the transmission member 14 can be fitted while changing a relative attaching turning angle by every 45° with the cylindrical member 7e.

Further, a pair of switch operation members 17a and 17b is attached to a front face of the base 5 with holding the thumb-turn cover 7 from either side thereof. Each of the switch operation members 17a and 17b is a rod-like member long in a vertical direction, and can be swung in a horizontal direction around a lower end part thereof. Further, a contact projection 17c which contacts to a peripheral face of the circumference face 7b of the thumb-turn cover 7 is provided in a protruding manner inside the center part of the switch operation members 17a and 17b. Further, the upper ends of the switch operation members 17a and 17b are biased mutually in a pulling direction by the spring member 18. In addition, an operation piece 17d for carrying out an ON/OFF operation by contacting to/separating from a detection switch 9 as described below is installed upwardly in a protruding manner at the right and left outer upper ends of the switch operation members 17a and 17b (the switch operation member 17a on the left side has the operation piece 17d at the left end thereof, and the switch operation member 17b on the right side has the operation piece 17d at the right end thereof). As for the switch operation members 17a and 17b having such a configuration, when the contact projection 17c is contacted with the operation protruding strip 7c formed on a circumference part 7b and is pressed to the right and left outer sides, the upper ends of the switch operation members 17a and 17b are moved to an OFF position on the right and left outer sides. Here, when the contact projection 17c is contacted with a circumference face which is not the operation protruding strip 7c, the upper ends of the switch operation members 17a and 17b are kept at an ON position which is a deeper inner side than the OFF position by the spring member 18.

In addition, a housing part 19 capable of housing the motor 8 is provided on the front face of the base 5 and at a higher position than the window 10. The motor 8 is placed in the housing part 19 with capable of turning around the spindle in a horizontal direction.

Further, a base plate 20, which covers a front part of the motor 8 and extends to a front part of the thumb-turn cover 7, is attached with the base 5. The detection switches 9 and 9 which are electrically connected with a control device 3 described below are fixed on a back face of the basic plate 20 with the ON/OFF operation parts directed toward the right and left outer sides, respectively. Further, in a state that the basic plate 20 is attached to the base 5, each detection switch 9 is positioned at a deeper inner side than the operation piece 17d of each of the switch operation members 17a and 17b, and each ON/OFF operation part is arranged so as to contact to the operation piece 17d at an ON position and separate from the operation piece 17d at an OFF position.

It should be noted that in the present embodiment a first detection switch and a second detection switch are configured with one of the detection switch 9 and one of the switch operation member 17a or 17b, and the operation protruding strip 7c formed at the circumference face 7b of the thumb-turn cover 7 is made to be a switch operation means.

On the other hand, a gear housing part 21 capable of housing a plurality of gears 15a, 15b, . . . which constitute the gear mechanism 15 for transmitting a rotation drive of the motor 8 is formed on a front face of the basic plate 20 being recessed. Particularly, the gear 15a is placed to be rotated coaxially with the thumb-turn cover 7. Further, four projected parts 22, 22, . . . , which can fit to the recessed parts 7d, 7d . . . provided at the thumb-turn cover 7, are installed backwardly in a protruding manner at a phase angle of 90° on a back face of the gear 15a. Here, the gear 15a has an exposure hole 23 which can expose only the finger knob part 7a of the thumb-turn cover 7. The finger knob part 7a of the thumb-turn cover 7 can be operated manually from an external of the case member through an operation window 24 provided in an open manner at the front cover member 6. Further, the basic plate 20 has a piercing hole so that the rotary spindle of the motor 8 protrudes to a frontward side.

In the cover device 2 having the above-described configuration, the thumb-turn cover 7 is generally pushed out frontward by the ring spring 16, and the recessed parts 7d, 7d, of the thumb-turn cover 7 are fitted with the projected parts 22, 22, of the gear 15a. Therefore, when the motor 8 is rotated, the rotation is transmitted to the thumb-turn cover 7 through the gear mechanism 15. Then, the thumb-turn cover 7 is turned, so is the thumb-turn 1, and the locking and unlocking operations are carried out. Here, in this fitting state, the thumb-turn cover 7 is connected with the motor 8, and thus free turning thereof is restricted.

Further, when the thumb-turn cover 7 is pushed in backward to release the fitting of the recessed parts 7d, 7d, . . . and the projected parts 22, 22, . . . , the connection of the thumb-turn cover 7 and the motor 8 is released. Therefore, the thumb-turn cover. 7 can be turned manually. That is, when the finger knob part 7a is pinched in a pushing-in state and is turned by 90° in a left direction or a right direction, the thumb-turn 1 can carry out the locking and unlocking operations. Here, the recessed part 7d and the projected part 22 are provided at a phase angle of 90°, respectively. Thus, after the thumb-turn cover 7 is turned manually by 90° in the left direction or the right direction, the recessed part 7d and the projected part 22 can be fitted again, and both are automatically returned to the fitting state by the biasing force of the ring spring 16.

The control device 3 and the sensor 4 will be described below.

The control device 3 houses a control part 30 for controlling an operation of the cover device 2, a power supply part 31 for supplying electric power to the control part 30, the motor 8 and the like, a detection part 32 for detecting an opening and closing state of the door by the sensor 4, and the like. The control device 3 is placed proximity to an upper end of the door. On the other hand, the sensor 4 is a member for communication by which the control device 3 and the detection part 32 can be communicated only within a predetermined distance range. The sensor 4 is fixed at a higher position than the door and at a position where the distance between the sensor 4 and the control device 3 only in a case of closing the door is within the predetermined distance range.

Further, the control device 3 detects an ON/OFF state of the detection switches 9 and 9, and determines a turning position of the thumb-turn cover 7, that is, locking and unlocking states of the thumb-turn 1. The control device 3 controls a rotation drive of the motor 8 as follows while integrally appraising the determination and the detection states by the sensor 4. The control relating to the locking and unlocking operations by the control device 3 will be described as shown in FIGS. 10 and 11. FIG. 10 is a back explanatory view of the cover device 2 in the unlocking state, and FIG. 11 is a back explanatory view of the cover device 2 in a locking state, in which the thumb-turn cover 7 is turned by 90° in a left direction from the unlocking state. Here, in FIGS. 10 and 11, the metal fixture 11, the base 5 and the like are omitted.

First, determination of the unlocking state or the locking state of the control part 30 will be described below.

As for the switch operation members 17a and 17b, when the finger knob part 7a is in the unlocking state where it takes a vertical position as illustrated in FIG. 10, the contact projections 17c and 17c are pushed out towards right and left outer directions by the both ends operation protruding strips 7c and 7c formed on the circumference face 7b of the thumb-turn cover 7. Thereby, the upper ends are moved to the OFF position on the right and left outer sides. Therefore, it is set that the operation pieces 17d and 17d are separated from the detection switches 9 and 9, both the detection switches 9 and 9 are to be OFF, and the control part 30 determines this state as the unlocking state.

On the other hand, when the thumb-turn cover 7 is turned by 90° in the left direction and the finger knob part 7a is in the locking state where it takes a horizontal position as illustrated in FIG. 11, only the switch operation member 17a on the left side when viewed from the front is moved to the OFF position by the operation protruding strip 7c at the middle position, and the switch operation member 17b on the right side when viewed from the front is maintained at the ON position. That is, the detection switch 9 on the left side is to be OFF, and the detection switch on the right side is to be ON. Further, the control part 30 is set so as to determine the locking state when detecting the detection switch 9 on the right side only being in the ON state (a predetermined state). Here, when the thumb-turn cover 7 is positioned at the middle between the locking position and the unlocking position, both the detection switches 9 and 9 are in the ON state.

A control by the control part 30 based on the above-described determination will be described below.

The control part 30 maintains the locking state in general. When determining the unlocking state with the thumb-turn cover 7 being turned by the above-described manual operation or the like, the control part 30 rotates the motor 8 in the locking direction until determining the locking state and automatically locks the door after a predetermined time passes from the determination of the unlocking state. Here, as for measuring of the predetermined time, the time is measured only when the detection by a magnet between the door and the sensor 4 is completed, and thus the locking operation cannot be carried out with the door being opened.

On the other hand, when a predetermined unlocking operation is carried out in the unlocking device (e.g., putting a card key over the unlocking device), the control part 30 rotates the motor 8 in the unlocking direction until the unlocking state is determined.

The control regarding the locking and unlocking operations by the control part 30 is carried out according to the above-described processes.

According to the electric lock device having the above-described configuration, the cover device 2 has a configuration in which the recessed parts 7d, 7d,. . . are provided at the thumb-turn cover 7, the projected parts 22, 22, are provided at the gear 15a of the gear mechanism 15 for transmitting the rotation of the motor 8 to the thumb-turn cover 7, and the motor 8 and the thumb-turn cover 7 are connected by fitting the projected part 22 and the recessed part 7d. Further, the cover device 2 includes the thumb-turn cover 7 capable of advancing or retracting in the anteroposterior directions, and enables to fit/release the projected part 22 and the recessed part 7d by an advancing or retracting operation of the thumb-turn cover 7. Therefore, the thumb-turn cover 7 can be manually turned only by a pushing-in operation of the thumb-turn cover 7 without any restrictions, and thus a switching configuration from an electric operation to a manual operation can be simplified more than ever before. Further, since the unlocking operation can be carried out easily by a manual operation, it is not necessary to provide a separate device, which makes the electric lock device carry out the unlocking operation, inside the door. Therefore, a compactification of the device and a simplification of a placing operation or the like can be achieved, and thus a reduction in cost can be promoted.

Further, as described above, it is necessary to advance and retract the thumb-turn cover 7 in the anteroposterior directions for carrying out a manual operation, and thus an illicit unlocking by a thumb-turn turning or the like can be effectively prevented. Further, since the thumb-turn cover 7 is biased frontward by the ring spring 16, a load against the biasing force is required for a pushing-in operation of the thumb-turn cover 7, and thus the above-described crime prevention effect can be enhanced more effectively. Further, since an electric operation state, where the projected part 22 and the recessed part 7d are fitted together, can be automatically returned after the manual operation, it is useful.

Further, the three operation protruding strips 7c, 7c, are provided at a phase angle of 90° on the circumference face 7b of the thumb-turn cover 7, and the switch operation members 17a and 17b having the contact projection 17c contacting to the circumference of circumference face 7b is provided as opposing each other with holding the circumference face 7b of the thumb-turn cover 7. Further, the switch operation members 17a and 17b are provided so that the upper ends of the switch operation members 17a and 17b are made to be moved in the horizontal direction by holding the lower ends of the members with a axis when the contact projection 17c contacts to the operation protruding strip 7c. Further, the two detection switches 9 and 9 are provided so that the operation pieces 17d of each of the switch operation members 17a and 17b contacts/separates to carry out the ON/OFF operation according to the horizontal movements of the switch operation members 17a and 17b. Further, the control part 30 of the control device 3 detects the ON/OFF state of the detection switches 9 and 9, and determines the turning position of the thumb-turn cover 7 and the locking and unlocking states of the thumb-turn 1 as described above. Accordingly, the turning position of the thumb-turn cover 7 can be accurately determined by the two detection switches 9 and 9 to enable to control the locking and unlocking operations. When comparing with a conventional electric lock device, the number of switches to be used can be reduced. Accordingly, a compactification of the device, and a simplification of the production and the control by the control part 30 can be promoted.

Furthermore, each operation protruding strip 7c on the circumference face 7b is formed so that the length in the anteroposterior directions thereof is longer than the advancing and retracting distance in the anteroposterior directions of the thumb-turn cover 7. Therefore, when the thumb-turn cover 7 is not only electrically turned but also manually turned by a pushing-in operation, the operation protruding strip 7c can be contacted with the contact projection 17c. Thus, the turning position of the thumb-turn cover 7 can be accurately detected by the detections switches 9 and 9. Therefore, the configuration of the electric lock device can be rationalized, and a reduction in the number of parts and a compactification of the device can be promoted.

Furthermore, in the electric lock device of the present embodiment, the cover device 2 internally having the motor 8 for rotating the thumb-turn 1 is separately provided from the control device 3 internally having the control part 30 for controlling the rotation drive of the motor 8, and the power supply part 31 for supplying power to the motor 8 or the like is provided in the control device 3. Therefore, the cover device 2 can be more compactified than the conventional electric lock device in which the control part and the power supply part are integrally placed in the cover device. Thus the cover device 2 can be attached proximity to the thumb-turn 1 without having been protruded from the door. Further, since the power supply part 31 is housed in the control device 3, a wiring work can be more simplified than that of an electric lock device depended on an external power supply.

In addition, the thumb-turn cover 7 and the thumb-turn 1 are interlocked through the transmission member 14 which can be attached while the relative turning angle is changed at every 45° with respect to the thumb-turn cover 7. By interlocking the thumb-turn cover 7 and the thumb-turn 1 through the transmission member 14 as described, the electric lock device can be placed regardless of an operation mode of the existing thumb-turn 1, and thus it becomes excellent in versatility. Further, since the cover device 2 can be placed with a constant fixed position, there is no problem that the appearance is deteriorated due to the placed cover device 2.

It should be noted that the electric lock device according to the present invention is not limited to the above-described embodiment. The configuration according to the cover device and the control device can be appropriately changed if necessary within a range not departing from the object of the present invention.

For example, although the above-described embodiment has a configuration that the device is placed at a left-hand door when viewed from inside of the door, the cover device 2 or the control device 3 can be placed at a right-hand door. In this case, where the thumb-turn cover 7 is turned by 90° in the right direction and the finger knob part 7a takes a horizontal position, it is in the locking state as illustrated in FIG. 12. In other words, contrary to the device described in the above-described embodiment, only the switch operation member 17b on the right side is moved to the OFF position by the operation protruding strip 7c at the middle, and the switch operation member 17a on the left side is maintained at the ON position. This can be dealt by setting the control part 30 such that the control part 30 determines that it is in a locking state when detecting the state that only the detection switch 9 on the left side is in the ON state (a predetermined state), and making the rotating direction of the motor 8 at the time of determining the unlocking state in a direction opposite to that of the above-described embodiment. Therefore, the electric lock device can be used regardless of left-hand door or right-hand door, and thus is excellent in versatility.

Further, the above-described embodiment configures a clutch mechanism with providing the recessed part 7d at the thumb-turn cover 7 and the projected part 22 at the gear 15a. However, it is also possible to have a configuration that a clutch member, which locks the thumb-turn cover 7 at only a predetermined operation position, is separately provided and the connection of the motor 8 and the thumb-turn cover 7 is connected/released by operating the clutch member. Further, the connection of the thumb-turn cover 7 and the motor 8 can be configured to be released by a frontward pulling-out operation of the thumb-turn cover 7 instead of the pushing-in operation. In addition, when the clutch mechanism is formed with the projected part 22 and the recessed part 7d, the side which the projected part is provided can be changed appropriately in a design.

Further, the right-and-left position relation between the detection switch 9 and the operation piece 19d can be configured reversely. In this case, although the ON/OFF state of the detection switches 9 and 9 in association with the turning position of the thumb-turn cover 7 is contrary to that of the above-described embodiment (e.g., the unlocking state is determined when both the detection switches 9 and 9 are in the ON state), there is no problem in detection accuracy and usability, and the predetermined condition (that is, the condition that only a first detection switch and a second detection switch are operated by a switch operation means) is not changed.

Further, it is possible to have configurations that an operational recessing strip is provided instead of the operation protruding strip 7c being provided on the circumference face 7b of the thumb-turn cover 7, and the upper ends of the switch operation members 17a and 17b are moved by fitting the contact projection 17c into the operational recessing strip, thereby making the detection switches 9 and 9 carry out the ON/OFF operation. Further, instead of providing the switch operation members 17a, 17b and the like, the detection switch 9 can be provided so that the operation protruding strip 7c directly operates the detection switch 9 to carry out the ON/OFF operation.

Furthermore, the numbers of the recessed groove 7f provided in the cylindrical member 7e and the engaging projection 14a provided at the transmission member 14 can be appropriately modified. Instead of making the numbers of the both equal, for example, the attaching turning angle of the transmission member 14 can be changed by providing a pair of engaging projections 14a and 14a to be opposed each other on the outer peripheral face of the transmission member 14, and by selecting the recessed groove 7f with which the engaging projections 14a and 14a are engaged.

Here, there is no problem in separately placing an unlocking device having an unlocking button or the like for making the control device 3 carry out the unlocking operation inside the door so as to carry out both the electric and manual unlocking operations.

### BRIEF DESCRIPTION OF THE DRAWINGS

FIG. 1 It is an overall view to illustrate an electric lock device placed at a door.

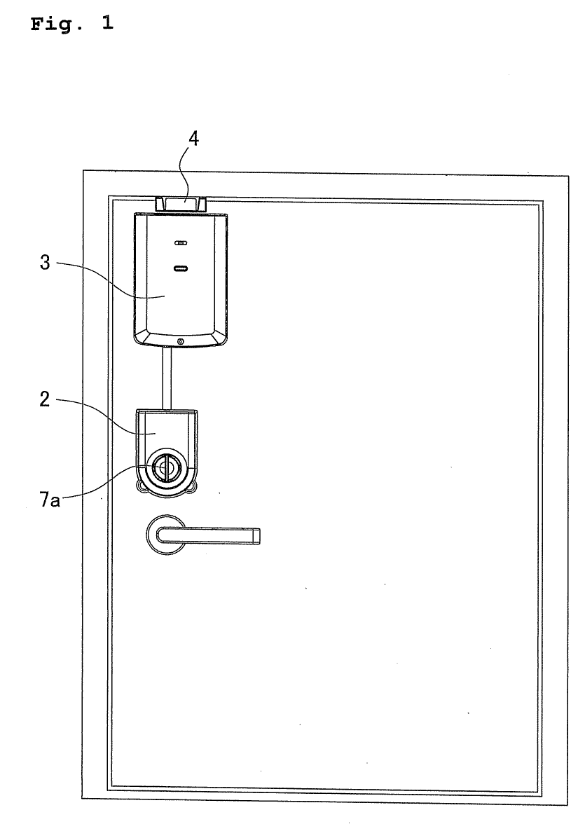

FIG. 2 It is a block configuration diagram of an electric lock device.

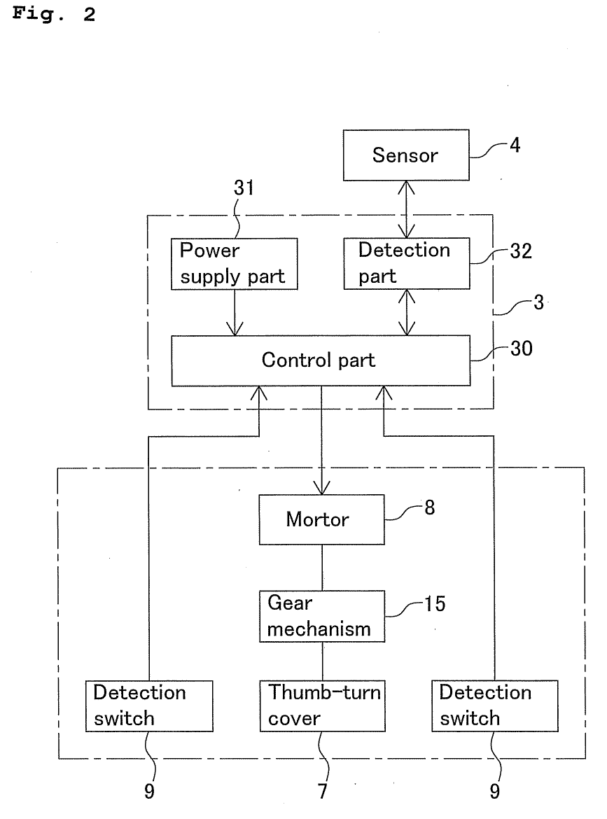

FIG. 3 It is a front explanatory view of a cover device.

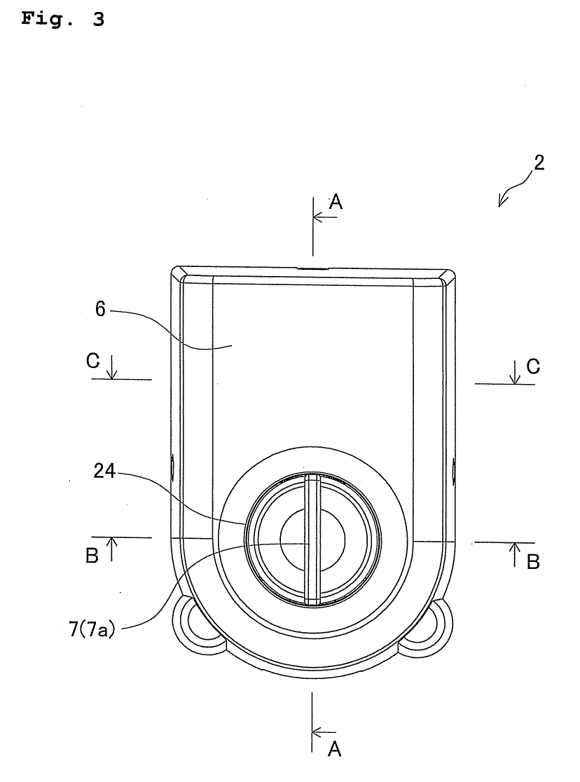

FIG. 4 It is a back explanatory view of a cover device.

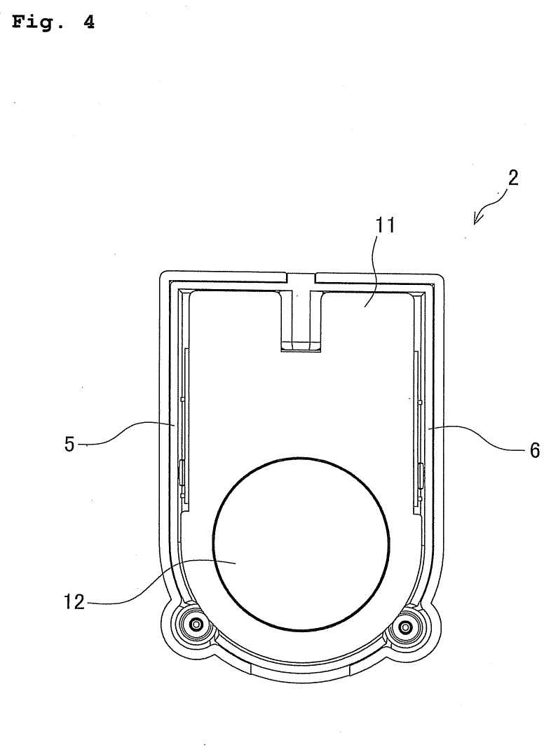

FIG. 5 It is a front perspective explanatory view of a disassembled cover device.

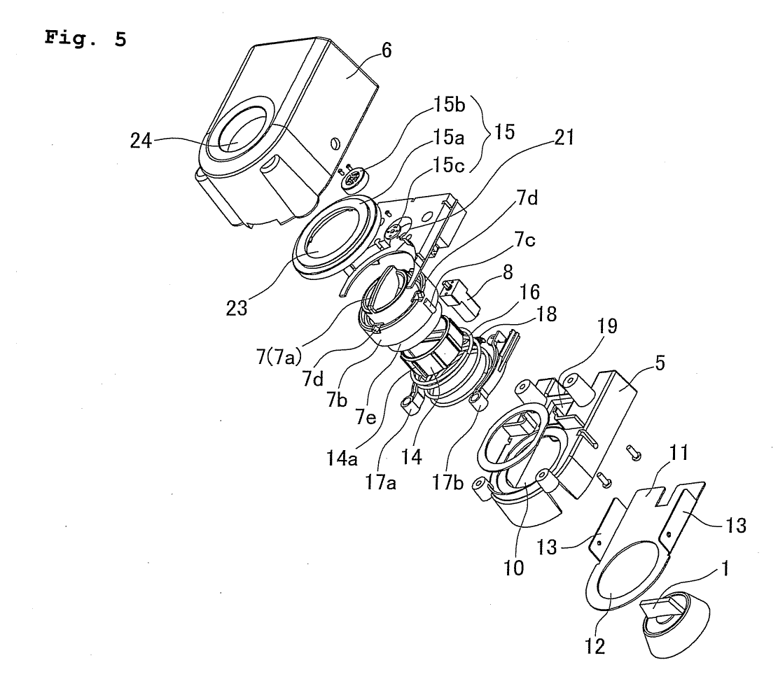

FIG. 6 It is a back perspective explanatory view of a disassembled cover device.

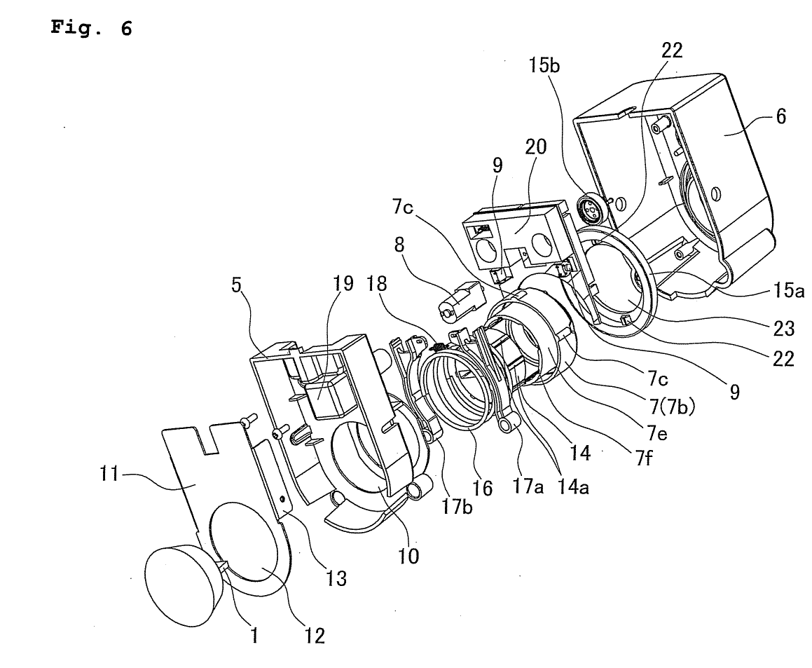

FIG. 7 It is a cross sectional explanatory view taken along an A-A line in FIG. 3.

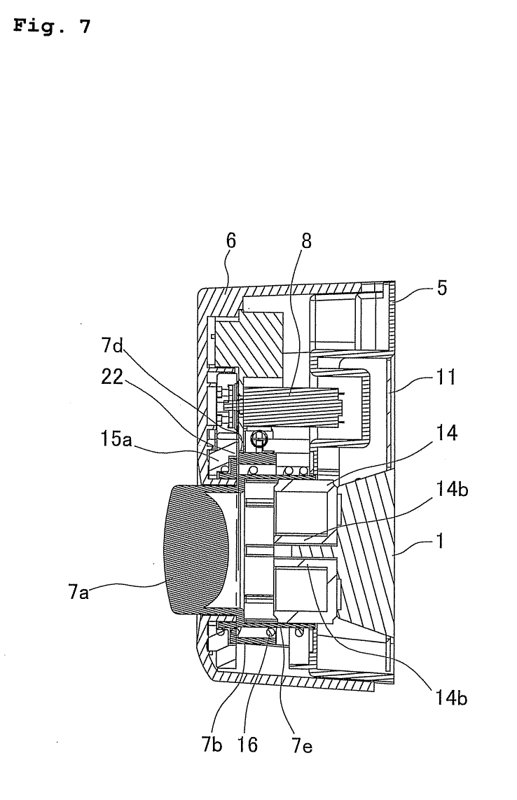

FIG. 8 It is a cross sectional explanatory view taken along a B-B line in FIG. 3.

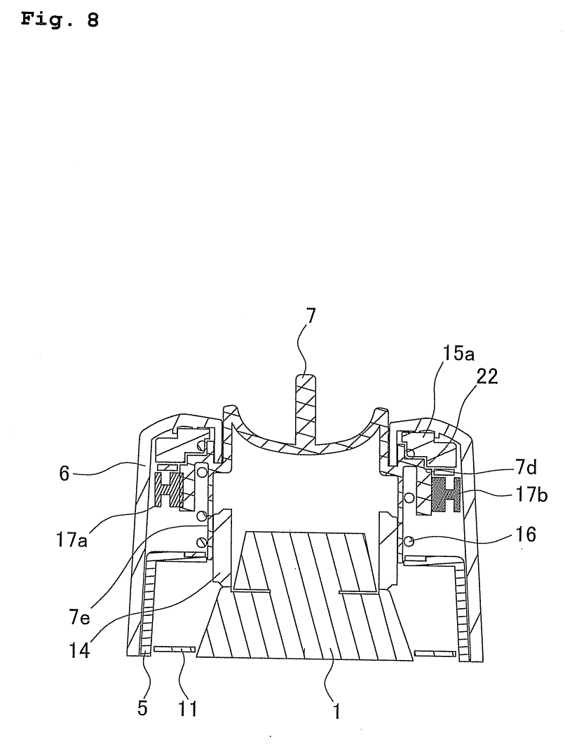

FIG. 9 It is a cross sectional explanatory view taken along a C-C line in FIG. 3

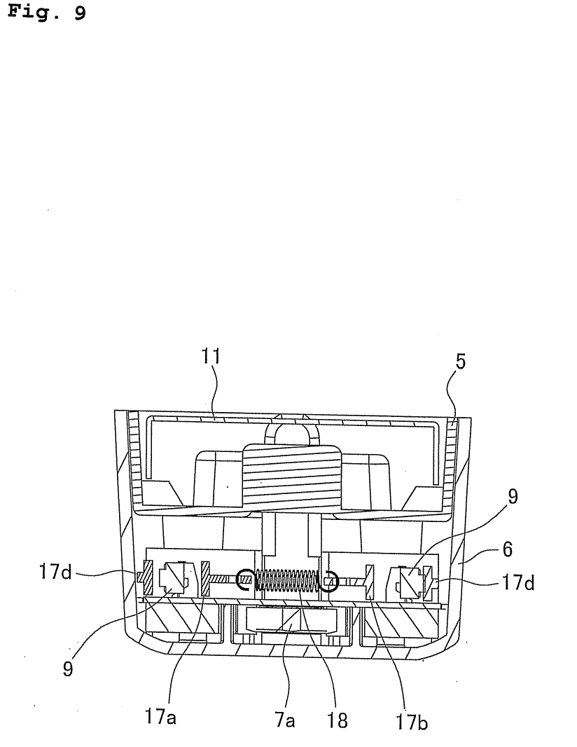

FIG. 10 It is an explanatory view to illustrate a cover device in an unlocking state from a back face side.

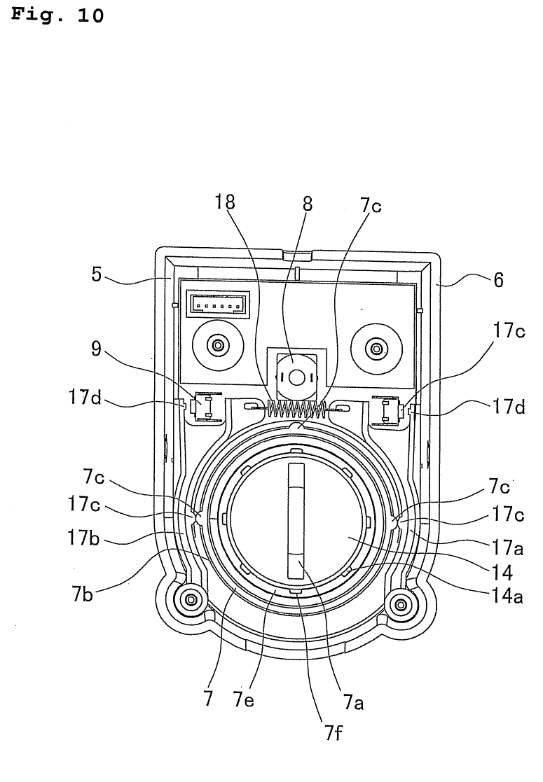

FIG. 11 It is an explanatory view to illustrate a cover device in the locking state in which a thumb-turn cover is turned by 90° in a left direction from the unlocking state

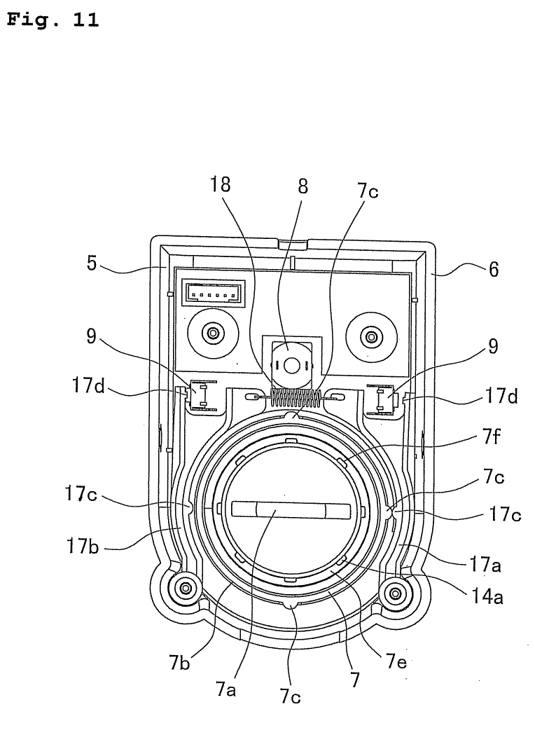

FIG. 12 It is an explanatory view to illustrate a cover device in a locking state in which the thumb-turn cover is turned by 90° in a right direction from the unlocking state

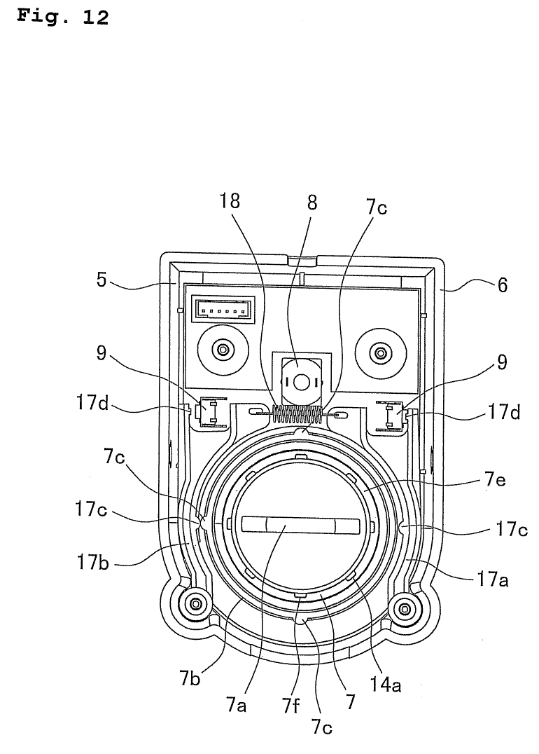

### EXPLANATION OF REFERENCE NUMERALS

1: Thumb-turn cover
2: Cover device (first casing)
3: Control device (second casing)
4: Sensor
5: Base
6: Front cover member
7: Thumb-turn cover
7a: Finger knob part
7b: Circumference face
7c: Operation protruding strip (switch operation means, projected part)
7d: Recessed part (clutch mechanism)
7e: Cylindrical member
7f: Recessed groove (engaged part)
8: Motor (driving device)
9: Detection switch (first detection switch, second detection switch)
10: Window
11: Metal fixture
14: Transmission member
14a: Engaging projection (engaging part)
14b: Holding rib piece
15: Gear mechanism
15a to 15c: Gears
16: Ring spring (biasing means)
17a, 17b: Switch operation members (first detection switch, second detection switch)
17c: Contact projection
17d: Operation piece
18: Spring
19: Housing part
20: Base plate
22: Projected part (clutch mechanism)
30: Control part
31: Power supply part (Electric power supply)
32: Detection part

1. An electric lock device comprising:
a driving device for turning a thumb-turn;
a thumb-turn cover attached covering the thumb-turn and being turned corresponding to an operation of the driving device so as to turn the thumb-turn;
a control device for determining whether being locked or unlocked by a turning position of the thumb-turn cover, and controlling the driving device;
a first casing internally having the driving device and the thumb-turn cover;
a second casing internally having the control device; and
an electric power supply built in the second casing, for supplying electric power to the control device and the driving device.

2. The electric lock device according to claim 1, wherein the thumb-turn cover includes:
a cylindrical member of which centre axis is a turning axis extending backward in a horizontal direction;
a plurality of engaging members on an inner circumference of the cylindrical member; and
a transmission member having a holding member capable of holding the thumb-turn and an engaging part on an outer peripheral face thereof so as to engage to the engaging member; wherein
the transmission member interlockably connects the thumb-turn cover and the thumb-turn; and
an attaching angle with the cylindrical part of the transmission member can be changed by turning and selecting the engaging member which the engaging part engages.

3. The electric lock device according to claim 1, wherein
the thumb-turn cover is provided capable of advancing and retracting along a rotary axis; wherein
one of a projected part and a recessed part to be fitted each other is provided at the thumb-turn-cover, and the other part is provided at a gear mechanism for connecting the thumb-turn cover and the driving device; and wherein
when the fitting of the projected part and the recessed part is released by a pushing-in operation of the thumb-turn cover towards a thumb-turn side, the connection by the gear mechanism is released, whereby a turning operation of the thumb-turn cover can be carried out without the driving device being operated.

4. The electric lock device according to claim 2, wherein
the thumb-turn cover is provided capable of advancing and retracting along a rotary axis; wherein
one of a projected part and a recessed part to be fitted each other is provided at the thumb-turn-cover, and the other part is provided at a gear mechanism for connecting the thumb-turn cover and the driving device; and wherein
when the fitting of the projected part and the recessed part is released by a pushing-in operation of the thumb-turn cover towards a thumb-turn side, the connection by the gear mechanism is released, whereby a turning operation of the thumb-turn cover can be carried out without the driving device being operated.
